(19) United States
(12) Patent Application Publication
(10) Pub. No.: US 2015/0082210 A1
(43) Pub. Date: Mar. 19, 2015

(54) SYSTEM AND METHOD FOR PROVIDING A VISUAL PREVIEW OF A USER INTERFACE HEAP DUMP

(71) Applicant: ORACLE INTERNATIONAL CORPORATION, Redwood Shores, CA (US)

(72) Inventor: Jiri Sedlacek, Horovice (CZ)

(73) Assignee: ORACLE INTERNATIONAL CORPORATION, REDWOOD SHORES, CA (US)

(21) Appl. No.: 14/198,361

(22) Filed: Mar. 5, 2014

Related U.S. Application Data
(60) Provisional application No. 61/879,918, filed on Sep. 19, 2013.

(51) Int. Cl. G06F 3/0484

(52) U.S. Cl. CPC G06F 3/04842
USPC 715/763

(57) ABSTRACT

A system and method for providing a visual preview of a heap dump, such as an application user interface heap dump. In accordance with an embodiment, the system comprises a software development environment including a heap dump viewer logic, wherein the heap dump viewer logic receives input from a user to select and display an instance of a heap dump or source elements therein, accesses the heap dump to determine information related to the selected instance or source elements, and builds graphical components corresponding to the selected instance or source elements, for use in generating a visual preview of the selected instance or source elements, for display to the user.

### CLAIM OF PRIORITY

This application claims the benefit of priority to U.S. Provisional Patent Application titled “SYSTEM AND METHOD FOR PROVIDING A VISUAL PREVIEW OF A USER INTERFACE HEAP DUMP”, Application No. 61/879,918, filed Sep. 19, 2013, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to software development, and are particularly related to a system and method for providing a visual preview of a heap dump, such as an application user interface heap dump.

### BACKGROUND

A common aspect of software application development is the design and development of application components such as graphical user interfaces. During the development process it can be useful for a developer to view the application components as maintained within the system's memory or heap. For example, the current contents of the heap can be written to a heap dump which can then be viewed or otherwise examined using a heap dump viewer. However, heap dump viewers intended for use with graphical user interface development typically display an exact in-memory representation for an object in a textual or numeric form. This form of representation is not ideal for many types of user interface objects.

### SUMMARY

Described herein is a system and method for providing a visual preview of a heap dump, such as an application user interface heap dump. In accordance with an embodiment, the system comprises a software development environment including a heap dump viewer logic, wherein the heap dump viewer logic receives input from a user to select and display an instance of a heap dump or source elements therein, accesses the heap dump to determine information related to the selected instance or source elements, and builds graphical components corresponding to the selected instance or source elements, for use in generating a visual preview of the selected instance or source elements, for display to the user.

### BRIEF DESCRIPTION OF THE FIGURES

FIG. 1 illustrates a system that can provide a visual preview of a user interface heap dump, in accordance with an embodiment.

FIG. 2 further illustrates a system that can provide a visual preview of a user interface heap dump, in accordance with an embodiment.

FIG. 3 further illustrates a system that can provide a visual preview of a user interface heap dump, in accordance with an embodiment.

FIG. 4 illustrates a process for providing a visual preview of a user interface heap dump, in accordance with an embodiment.

FIG. 5 illustrates an example environment that can utilize a visual preview of a user interface heap dump, in accordance with an embodiment.

FIG. 6 further illustrates an example environment that can utilize a visual preview of a user interface heap dump, in accordance with an embodiment.

FIG. 7 further illustrates an example environment that can utilize a visual preview of a user interface heap dump, in accordance with an embodiment.

### DETAILED DESCRIPTION

As described above, a common aspect of software application development is the design and development of application components such as graphical user interfaces. However, heap dump viewers intended for use with graphical user interface development typically display an exact in-memory representation for an object in a textual or numeric form, which is not ideal for many types of user interface objects.

For example, a heap dump viewer may display classes and instances allocated on the heap, including fields, values and references. These textual and numerical properties generally reflect the object's representation in memory. The information can be useful in identifying and examining data structures, perhaps to eventually discover a software bug (e.g., a memory leak, or inefficient memory usage). However, for many types of objects, such in-memory representation is not ideal for quickly determining what the object is. For example, the representation may indicate the bytes of an image, rather than showing the actual image itself.

In accordance with an embodiment, described herein is a system and method for providing a visual preview of a heap dump, such as an application user interface (UI) heap dump for a software application, for example during its development or testing.

In accordance with an embodiment, the system comprises a software development environment including a heap dump viewer logic (referred to herein in some embodiments as HeapWalker), wherein the heap dump viewer logic receives input from a user to select and display an instance of a heap dump or source elements therein, accesses the heap dump to determine information related to the selected instance or source elements, and builds graphical components corresponding to the selected instance or source elements, for use in generating a visual preview of the selected instance or source elements, for display to the user.

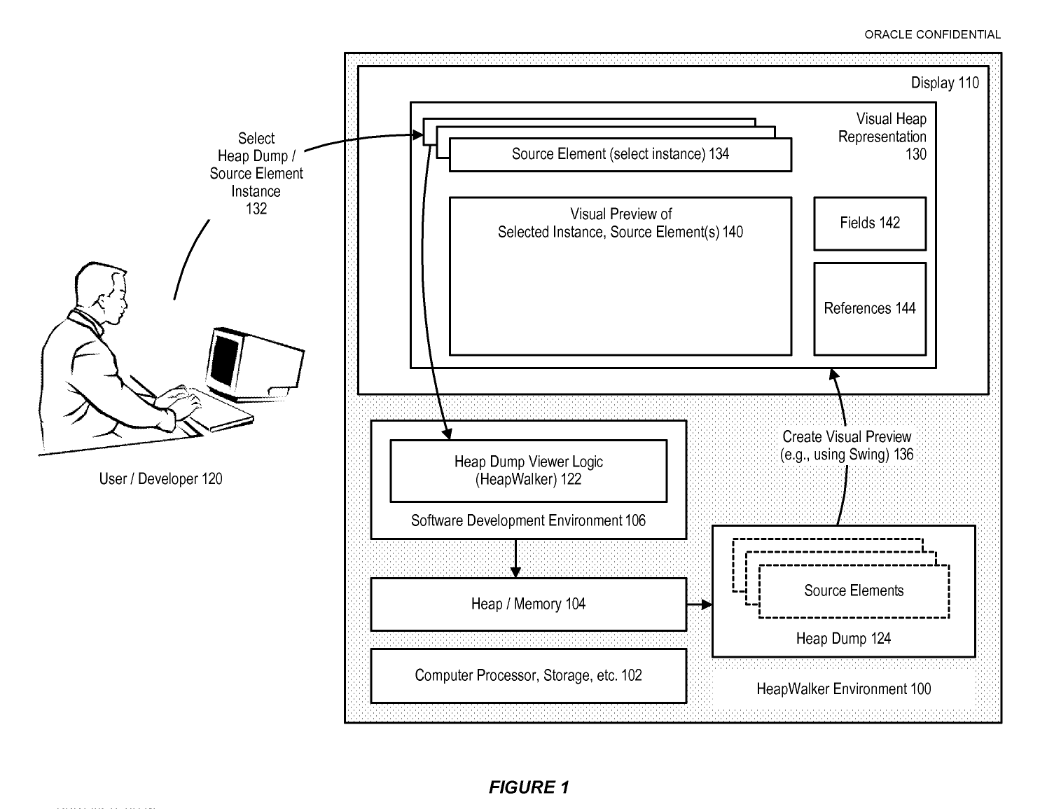

FIG. 1 illustrates a system that can provide a visual preview of a user interface heap dump, in accordance with an embodiment.

As shown in FIG. 1, in accordance with an embodiment, the system can include a computer environment 100, having a processor 102 and a memory which allows a software application being developed or debugged, including its software objects, to run within a memory heap 104.

In accordance with an embodiment, a software development environment 106, e.g., an Oracle JDeveloper, NetBeans, Visual VM, Java VisualVM, or other software development environment, is provided, which allows a user 120, e.g., a software developer, to develop and/or debug software applications.

In accordance with an embodiment, the system enables a visual preview for selected object types. Support for different object types can be extended with additional object types over time. For example, in the case of a software application's user interface elements, simply displaying an object's properties may not be optimal for the user to identify which part of the application's user interface that particular object represents. As another example, by just reading position, size and references to nested elements of a UI container, the user may not be able to readily determine that those nested elements represent, e.g., an Open File dialog created by the application.

In accordance with an embodiment, the software development environment includes a heap dump viewer logic 122, which receives input 132 from a user to select 134 and displays an instance of a heap dump or source elements therein. The heap dump viewer logic then accesses the heap dump 124 to determine information related to the selected instance or source elements, and builds graphical components 136 corresponding to the selected instance or source elements. The graphical components can then be used in generating a visual heap representation 130, including a visual preview 140 of the selected instance or source elements, for display to the user.

In accordance with an embodiment, the visual heap representation can also display a list of classes present on the heap, and fields 142 and references 144 to each instance.

In accordance with an embodiment, the graphical components can be Swing components. In accordance with other embodiments, Swing components can be used to represent other forms of graphical components, e.g., Standard Widget Toolkit (SWT) or JavaScript Widget Toolkit (JWT) components, based on visual similarities between the Swing components and the represented graphical components. In accordance with an embodiment, the system can be used with different environments, to support the user interface components generated by those different environments. As an illustrative example, when used with or ported to an Eclipse IDE environment, the system can generate SWT components. Similarly, when used with or ported to a web application environment, the system can generate JWT components.

In accordance with an embodiment, the heap dump viewer logic is configured to read just the relevant properties of the selected source, e.g., UI element, and display its visual appearance as precisely as possible given that the software application being developed could have been executed on a different and/or incompatible system.

In this manner, the user can, for example, examine software application features, including logical UI structures such as Buttons, Menus, Dialogs or application windows, and readily identify those parts of the application's user interface which should not be kept in memory. Similarly, the user can use the heap dump viewer to review the application state at the time of dumping the heap.

As described above, in accordance with an embodiment, the system builds and displays Swing components for those source instances or elements selected by the user. In accordance with an embodiment, for custom components, an appropriate Swing superclass can be used. Alternatively, a placeholder component displaying the real element type can be used. For UI containers, a list of visible nested components can be created, building up to the entire application user interface.

In accordance with an embodiment, the system can be configured to be modular, such that support for additional types of source elements and graphical components can be added if desired. For example, as described above the visual preview can be created using Swing; however the source elements being previewed can be of any type, including AWT or SWT elements, if there is an appropriate Swing component/snippet available to represent them.

In accordance with an embodiment, the system can also be configured to support a variety of image types and formats stored in heap, and can again be designed in a modular fashion such that support for other image types can be added as necessary.

In accordance with an embodiment, the system can be configured for optimal performance. For example, required values can be read from the heap dump in a worker thread, and the UI preview built later in an event dispatch thread. The graphical element/UI building phase can also be designed to be interruptible, so that rendering of a long-running preview for a large user interface can be canceled by the user at any time.

In accordance with an embodiment, the system can be configured so that the visual preview area can be detached from the heap viewer main window, and displayed within its own separate window, and/or can include additional tools or functionality for analyzing, e.g., a software application's UI structure and identifying original UI elements in the heap dump.

In accordance with an embodiment, the system can be used with or implemented within a JDeveloper, NetBeans, Visual VM, Java VisualVM, or other software development environment, to enable preview of selected objects, together with its properties (Point coordinates, Array items etc.), or the visual appearance of its UI attribute/element (e.g., Color, Font, Button).

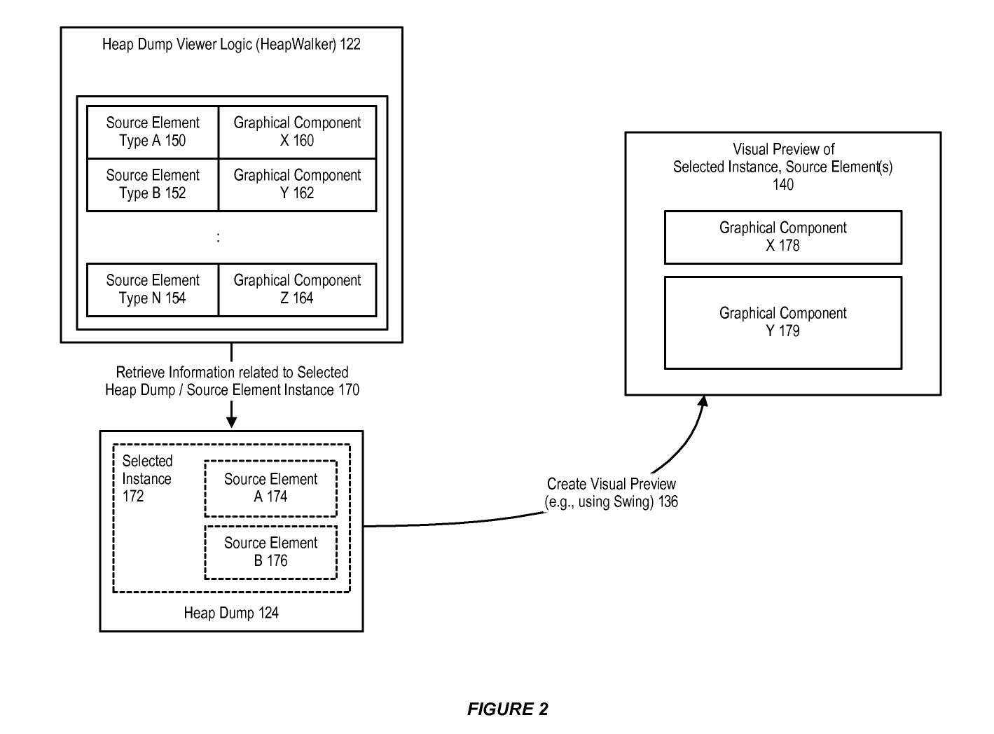

FIG. 2 further illustrates a system that can provide a visual preview of a user interface heap dump, in accordance with an embodiment. As shown in FIG. 2, in accordance with an embodiment, the heap dump viewer logic can include information that allows it to generate graphical components 160, 162, 163 corresponding to various source elements 150, 152, 154.

Upon receiving a request, e.g., from an application developer or user, to select and display a heap dump or source element instance, information related to the selected source element instance is retrieved 170 from the heap dump. The system can then build graphical components 178, 179 corresponding to the selected instance 172 or source elements 174, 176, for use in generating a visual preview of the selected instance or source elements.

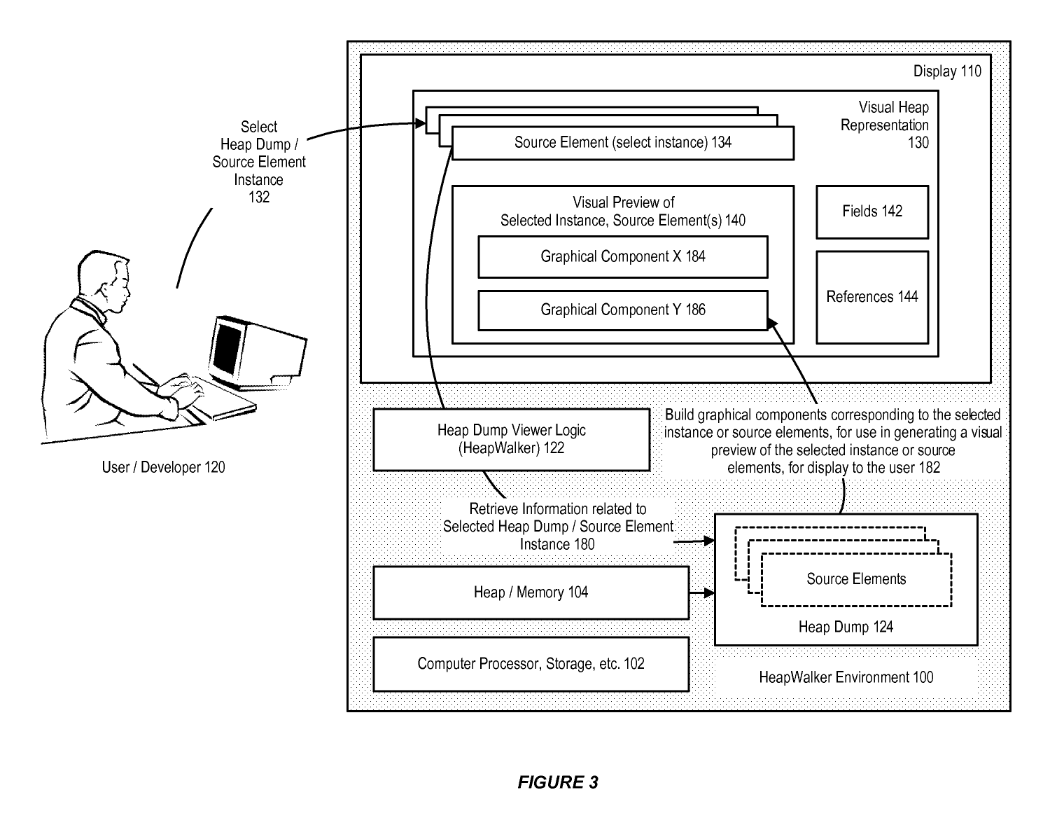

FIG. 3 further illustrates a system that can provide a visual preview of a user interface heap dump, in accordance with an embodiment. As shown in FIG. 3, in accordance with an embodiment, upon receiving input from a user to select and display an instance of a heap dump or source elements therein, the heap dump viewer logic can then access the heap dump 180 to determine information related to the selected instance or source elements, and build 182 graphical components, for use in generating a visual preview of the selected instance or source elements, for display to the user 184, 186.

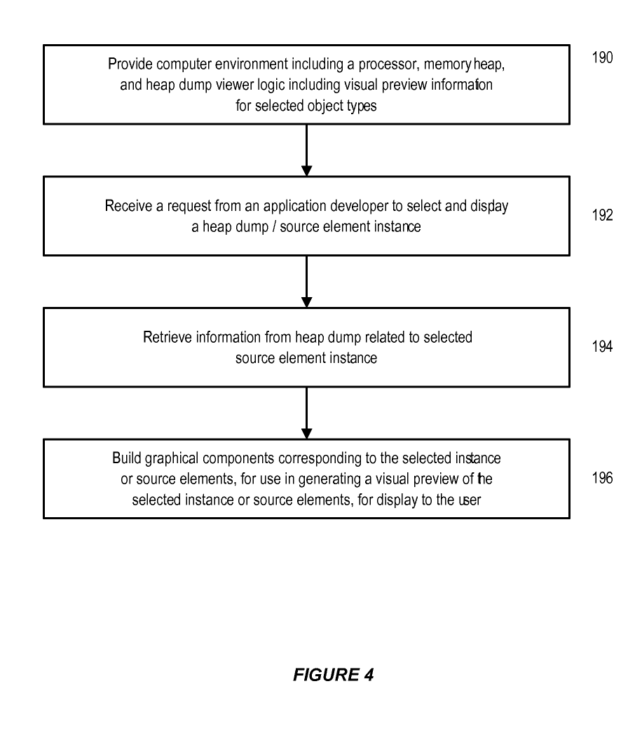

FIG. 4 illustrates a process for providing a visual preview of a user interface heap dump, in accordance with an embodiment. As shown in FIG. 4, in accordance with an embodiment, at step 190, a computer environment is provided, including a processor, memory heap, and heap dump viewer logic including visual preview information for selected object types.

At step 192, the system receives a request, e.g., from an application developer or user, to select and display a heap dump or source element instance.

At step 194, information related to the selected source element instance is retrieved from the heap dump.

At step 196, the system builds graphical components corresponding to the selected instance or source elements, for use in generating a visual preview of the selected instance or source elements, for display to the user.

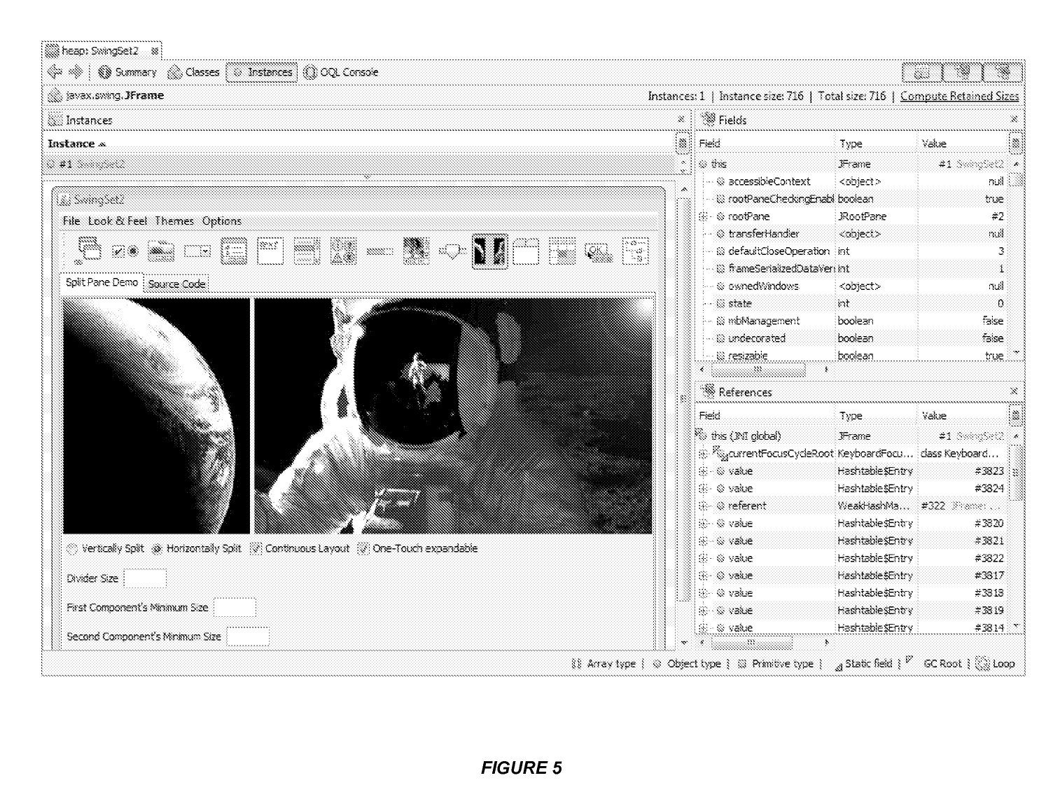

FIG. 5 illustrates an example environment that can utilize a visual preview of a user interface heap dump, in accordance with an embodiment. In particular, FIG. 5 illustrates a top level JFrame preview of a SwingSet2 demo application, in which a user or developer can display an application user interface instance.

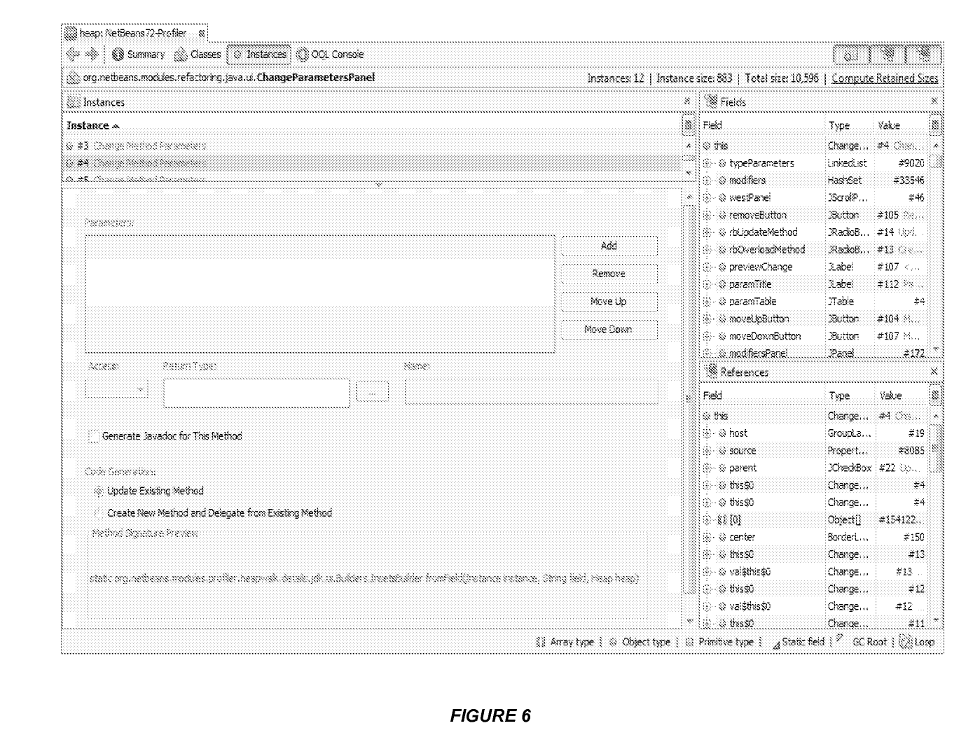

FIG. 6 further illustrates an example environment that can utilize a visual preview of a user interface heap dump, in accordance with an embodiment. In particular, FIG. 6 illustrates an example, using Netbeans, of a leaking refactoring dialog contents preview.

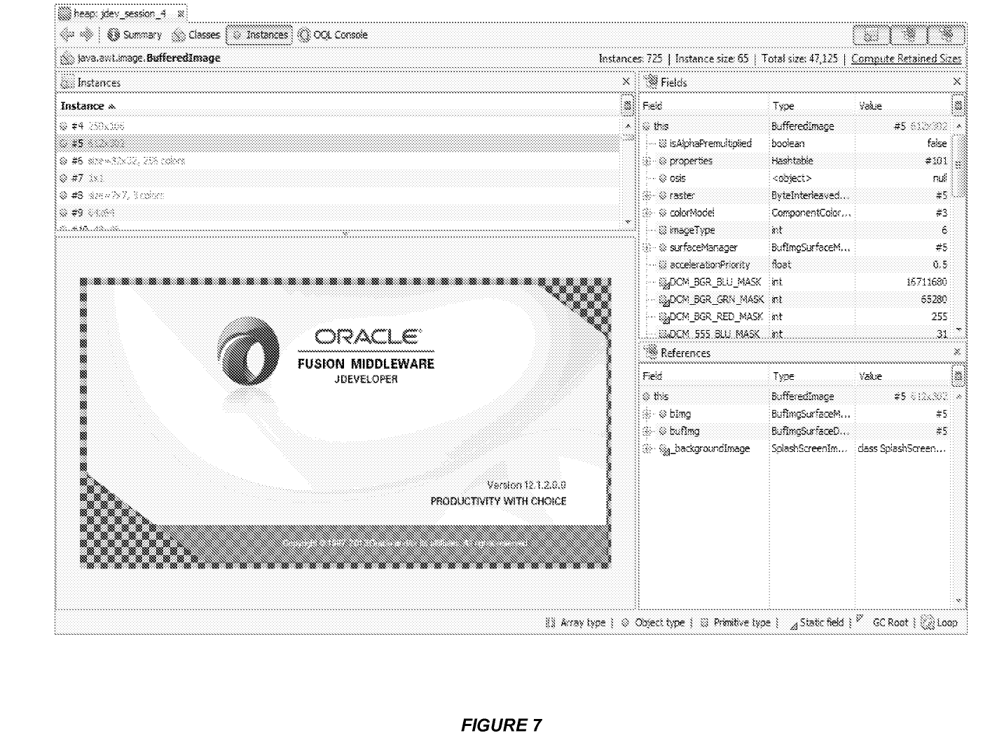

FIG. 7 further illustrates an example environment that can utilize a visual preview of a user interface heap dump, in accordance with an embodiment. In particular, FIG. 7 illustrates an example, using JDeveloper, of a leaking splash screen image preview.

Each of these examples illustrate how, in accordance with an embodiment, a user or developer can utilize the system to select a particular instance, wherein the system then accesses the heap dump to determine information related to the selected instance or source elements, and builds graphical components corresponding to the selected instance or source elements, for use in generating a visual preview of the selected instance or source elements, for display to the user.

### Use Cases

In accordance with various embodiments, the system can support different use cases which are enabled by introducing a visual preview of selected user interface elements. Examples of several use cases are described below. In accordance with various embodiments, other use cases can be supported.

1. Identifying a selected user interface element. As an illustrative example, a developer can use the system to find a particular UI source element type, such as Button or Label, by using the visual preview to browse instances of the desired type.

2. Determining an application state at the time of dumping the heap. As an illustrative example, bugs reported by users often do not contain necessary information and/or miss important details that are needed to properly address the bugs. By displaying the application UI, a developer can quickly see, e.g., that a text document was being loaded when an out-of-memory exception was thrown.

3. Searching for user interface snippets unintentionally kept in memory. As an illustrative example, parts of a UI are sometimes not being released from memory, which can cause problems, since tables, trees or editors often reference very large data models. By browsing, e.g., Panel elements, a developer can easily discover these snippets, to determine how much memory is being wasted and identify problems that prevent the UI from being released.

4. Discovering duplicities. As an illustrative example, by browsing, e.g., Images, a developer can quickly determine multiple instances of the same image being allocated in memory which is a waste of resources.

5. Performing offline user interface analysis. As an illustrative example, the system can be used to display the structure of a UI created from a heap dump. In this manner, a developer can analyze the UI building blocks without access to the actual application, which itself may be running on a different or incompatible system.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art.

For example, while several of the examples described above illustrate how an embodiment of the system builds and displays Swing components for those source instances or elements selected by the user, in accordance with other embodiments, other forms of graphical components can be generated, such as SWT, JWT, or other types of components.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for providing a visual preview of a heap dump, such as an application user interface heap dump, comprising:
a computer including a processor;
a memory heap for use during development of a software application; and
a software development environment including a heap dump viewer logic, wherein the heap dump viewer logic
receives input from a user to select and display an instance of a heap dump or source elements therein,
accesses the heap dump to determine information related to the selected instance or source elements, and
builds graphical components corresponding to the selected instance or source elements, for use in generating a visual heap representation of the selected instance or source elements, for display to the user.

2. The system of claim 1, wherein the software application includes a graphical user interface, and wherein the source elements are elements of the graphical user interface.

3. The system of claim 1, wherein the heap dump viewer logic builds the graphical components corresponding to the elements of the graphical user interface by generating corresponding Swing components.

4. The system of claim 1, wherein the visual heap representation includes a visual preview of the selected instance or source elements.

5. The system of claim 1, wherein the visual heap representation includes a list of classes present on the heap, and fields and references to each instance of the classes.

6. The system of claim 1, wherein the system is used with or implemented within a JDeveloper, NetBeans, VisualVM, Java VisualVM or other software development environment, to enable preview of selected objects, together with its properties.

7. The system of claim 1, wherein a visual preview area is detached from a heap viewer main window, and displayed within a separate window.

8. A non-transitory computer readable storage medium, including instructions stored thereon which when read and executed by one or more computers cause the one or more computers to perform the steps comprising:
providing a memory heap for use during development of a software application;
providing a software development environment including a heap dump viewer logic;
receiving input from a user to select and display an instance of a heap dump or source elements therein;
accessing the heap dump to determine information related to the selected instance or source elements; and
building graphical components corresponding to the selected instance or source elements, for use in generating a visual preview of the selected instance or source elements, for display to the user.

9. The non-transitory computer readable storage medium of claim 8, wherein the software application includes a graphical user interface, and wherein the source elements are elements of the graphical user interface.

10. The non-transitory computer readable storage medium of claim 8, wherein the heap dump viewer logic builds the graphical components corresponding the elements of the graphical user interface by generating corresponding Swing components.

11. The non-transitory computer readable storage medium of claim 8, where the visual heap representation includes a visual preview of the selected instance or source elements.

12. The non-transitory computer readable storage medium of claim 8, wherein the visual heap representation includes a list of classes present on the heap, and fields and references to each instance of the classes.

13. The non-transitory computer readable storage medium of claim 8, wherein the steps are implemented within a JDeveloper, NetBeans, VisualVM, Java VisualVM or other software development environment, to enable preview of selected objects, together with its properties.

14. The non-transitory computer readable storage medium of claim 8, wherein a visual preview area is detached from a heap viewer main window, and displayed within a separate window.

15. A method for providing a visual preview of a heap dump, such as an application user interface heap dump, comprising the steps of:
providing a memory heap for use during development of a software application;
providing a software development environment including a heap dump viewer logic;
receiving input from a user to select and display an instance of a heap dump or source elements therein;
accessing the heap dump to determine information related to the selected instance or source elements; and
building graphical components corresponding to the selected instance or source elements, for use in generating a visual preview of the selected instance or source elements, for display to the user.

16. The method of claim 15, wherein the software application includes a graphical user interface, and wherein the source elements are elements of the graphical user interface.

17. The method of claim 15, wherein the heap dump viewer logic builds the graphical components corresponding to the elements of the graphical user interface by generating corresponding Swing components.

18. The method of claim 15, where the visual heap representation includes a visual preview of the selected instance or source elements.

19. The method of claim 15, wherein the visual heap representation includes a list of classes present on the heap, and fields and references to each instance of the classes.

20. The method of claim 15, wherein the steps are implemented within a JDeveloper, NetBeans, VisualVM, Java VisualVM or other software development environment, to enable preview of selected objects, together with its properties.
